(19) United States
(12) Patent Application Publication
(10) Pub. No.: US 2021/0270485 A1
(43) Pub. Date: Sep. 2, 2021

(54) THERMOSTAT WITH POWER SAVING COMMUNICATIONS SYSTEM

(71) Applicant: Johnson Controls Technology Company, Auburn Hills, MI (US)

(72) Inventor: Leyla Mousavi, Milwaukee, WI (US)

(73) Assignee: Johnson Controls Technology Company, Auburn Hills, MI (US)

(21) Appl. No.: 16/803,623

(22) Filed: Feb. 27, 2020

(51) Int. Cl. F24F 11/46; F24F 11/64; F24F 11/65; G05B 19/042

(52) U.S. Cl. CPC F24F 11/46; F24F 11/64; F24F 2110/10; G05B 19/0426; F24F 11/65

(57) ABSTRACT

A system for controlling heating, ventilation, and/or air conditioning equipment includes a thermostat unit configured control the HVAC equipment and operate in at least one of a first operational state or a second, power-saving state, and a server comprising one or more processors. The processors are configured to receive one or more messages indicating changes to parameters of the thermostat unit, store the one or more messages in a storage table, receive a query from the thermostat unit responsive to the thermostat unit transitioning to the second state, the query indicating parameters of the thermostat unit and a state of the thermostat unit, retrieve, responsive to the query, a first one of the one or more message from the storage table, generate a first message based on the first one of the one or more messages and the query, and transmit the first message to the thermostat unit.

### BACKGROUND

A thermostat, in general, is a component of an HVAC control system. An HVAC system is a system that includes equipment for heating, cooling, and/or ventilating an environment. A thermostat may sense the temperature or other parameters (e.g., humidity) of an HVAC system and control components of the HVAC system in order to maintain a set point for the temperature or other parameter. In this regard, a thermostat may use a variety of sensors to measure temperature and other desired parameters of a building or system.

In some embodiments, a thermostat is connected to a network or the internet, or is otherwise internet-of-Things (TOT) enabled. In some such embodiments, a user may interact with the thermostat via a user device connected to the network or the internet. For example, a user may enter or change a temperature setpoint via the user device. IoT devices, including an IoT enable thermostat, may face power consumption challenges due to the frequent communication between the IoT device and the internet or network.

### SUMMARY

One embodiment of the present disclosure is a system for controlling heating, ventilation, and air conditioning (HVAC) equipment. The system includes a thermostat unit configured control the HVAC equipment and operate in at least one of a first state or a second state, where the first state is a power-saving state and the second state is an operational state, and a server includes one or more processors. The processors are configured to receive one or more messages indicating changes to parameters of the thermostat unit, store the one or more messages in a storage table, receive a query from the thermostat unit responsive to the thermostat unit transitioning to the second state, the query indicating parameters of the thermostat unit and a state of the thermostat unit, retrieve, responsive to the query, a first one of the one or more message from the storage table, generate a first message based on the first one of the one or more messages and the query, and transmit the first message to the thermostat unit.

In some embodiments, the thermostat unit is configured to receive a user input indicating a change to a parameter of the thermostat unit while the thermostat unit is in the first state, and where the query further indicates the user input.

In some embodiments, generating the first message further includes determining whether the first one of the one or more messages and the user input received by the thermostat unit indicate a similar change to the parameter of the thermostat unit, and merging the first one of the one or more messages and the user input based on a determination that the first one of the one or more messages and the user input do not indicate a similar change to the parameter.

In some embodiments, the one or more processors are further configured to retrieve, responsive to a determination that the first one of the one or more messages and the user input indicate a similar change to the parameter, a second one of the one or more message from the storage table, and generate the first message based on the second one of the one or more messages and the query.

In some embodiments, the thermostat unit is further configured to control the HVAC equipment according to the second message.

In some embodiments, the one or more processors are further configured to receive, from a user device, an operating schedule for the thermostat unit, where the thermostat unit is further configured to transition to the second state according to the operating schedule.

In some embodiments, the one or more processors are further configured to transmit, to the thermostat unit, an indication of a remaining number of the one or more messages stored in the storage table.

In some embodiments, the thermostat unit is configured to enter the first state responsive to an indication that there are no remaining messages of the one or more messages stored in the storage table.

In some embodiments, the one or more messages are stored in the storage table with a timestamp that indicates when each of the one or more messages was received.

In some embodiments, the server is a cloud based server and the server receives and transmits data in according to hypertext transfer protocol secure (HTTPS).

Another embodiment of the present disclosure is a method for controlling heating, ventilation, and air conditioning (HVAC) equipment. The method includes storing one or more messages indicating changes to parameters of a thermostat unit associated with the HVAC equipment in a storage table; receiving a query from the thermostat unit responsive to the thermostat unit transitioning to an operational state, the query indicating parameters of the thermostat unit; retrieving, responsive to the query, a first one of the one or more messages from the storage table; and transmitting a first message based on the first one of the one or more messages and the query to the thermostat unit.

In some embodiments, the thermostat unit is configured to receive a user input indicating a change to a parameter of the thermostat unit while the thermostat unit is in the power-saving state, and wherein the query further indicates the user input.

In some embodiments, the method further includes determining whether the first one of the one or more messages and the user input received by the thermostat unit indicate a similar change to the parameter of the thermostat unit; and merging the first one of the one or more messages and the user input based on a determination that the first one of the one or more messages and the user input do not indicate a similar change to the parameter.

In some embodiments, the method further includes retrieving, responsive to a determination that the first one of the one or more messages and the user input indicate a similar change to the parameter, a second one of the one or more message from the storage table, wherein the first message is based on the second one of the one or more messages and the query.

In some embodiments, the thermostat unit configured to control the HVAC equipment, the method further includes controlling, by the thermostat unit, the HVAC equipment based on the first message.

In some embodiments, the method further includes receiving, from a user device, an operating schedule for the thermostat unit, where the thermostat unit is configured to transition to the operational state from a power-saving state according to the operating schedule.

In some embodiments, the method further includes transmitting, to the thermostat unit, an indication of a remaining number of the one or more messages stored in the storage table.

In some embodiments, the thermostat unit is configured to enter a power-saving state responsive to an indication that there are no remaining messages of the one or more messages stored in the storage table.

In some embodiments, the one or more messages are stored in the storage table with a timestamp that indicates when each of the one or more messages was received.

Yet another embodiment of the present disclosure is a thermostat unit capable of communicating with one or more servers. The thermostat unit includes electronics configured to transmit a query to the server responsive to the thermostat entering a first operating mode, control heating, ventilation, or air conditioning equipment based on a first message from the server, the first message comprising a change to a parameter of the thermostat unit, determine a remaining number of messages to be received, and enter a second operating mode responsive to an indication that there are no messages to be received.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective view of a commercial building having a heating, ventilation, and/or air conditioning (HVAC) system, according to some embodiments.

FIG. 2 is a schematic drawing of a building equipped with a residential heating and cooling system and a thermostat, according to some embodiments.

FIG. 3 is a detailed diagram of the residential heating and cooling system of FIG. 2, according to some embodiments.

FIG. 4 is a drawing of a thermostat for use in the HVAC systems of FIG. 1 or 3, according to some embodiments.

FIG. 5 is a block diagram of a power saving communications circuit for the thermostat of FIG. 4, according to some embodiments.

FIG. 6 is a flow diagram illustrating a process for processing a parameter change via the power saving communications circuit of FIG. 5, according to some embodiments.

FIG. 7 is a flow diagram of a process for updating parameters of the thermostat of FIG. 4, according to some embodiments.

FIG. 8 is a flow diagram of a process for implementing a parameter change to a thermostat unit, according to some embodiments.

### DETAILED DESCRIPTION

### Overview

Referring generally to the FIGURES, a power saving communications system for a network connected or internet-of-things (IoT) enabled thermostat is described herein. The power saving communications circuit may help to reduce the energy consumption of a battery powered IoT enabled thermostat, thereby increasing the battery life of the device and decreasing required maintenance (e.g., due to changing batteries or charging the thermostat). The power saving communications system may help to reduce energy consumption of the thermostat in a number of ways.

In some embodiments, a thermostat coupled to the power saving communications system may only operate (i.e., run) or enter an operational state for short time intervals. For example, the thermostat may only need to turn on to communicate with a network or other components of the power saving communications system for a short period of time. The thermostat may transition to an operational state, check for new messages (i.e., data) that has been received by a server of the system while the thermostat was sleeping, receive any new messages, and transition back into a power-saving (i.e., sleep) mode. In some embodiments, the thermostat may wake (e.g., transition to the operational mode) at a regular time interval (e.g., every hour) to check for message. In this manner, the thermostat may conserve energy by only operating for short periods of time.

Additionally, the power saving communications circuit may utilize hypertext transfer protocol secure (HTTPS) for communications between the thermostat, server, and/or other components of the system. Communications via HTTPS may require less energy than other communication protocols, as HTTPS does not require an “always active” communication path (i.e., constant communication between components). In this manner, HTTPS may be better suited for low-energy communications between a thermostat and a server when compared to other communication protocols such as MQTT

### Commercial and Residential HVAC Systems

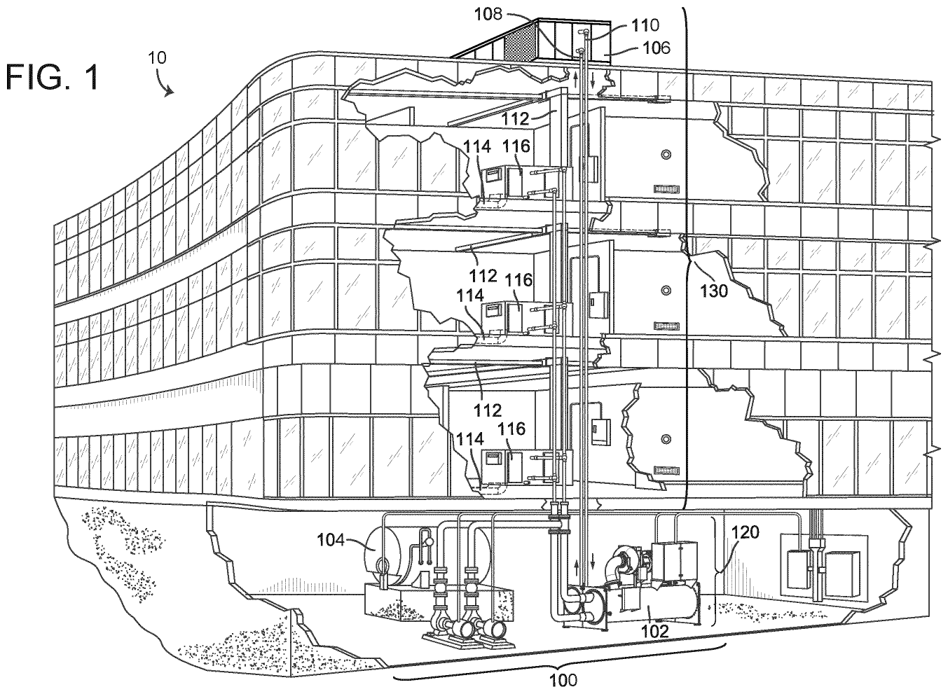

Referring now to FIG. 1, a perspective view of a commercial building 10 having a building management system (BMS) (i.e., a building automation system (BAS)) is shown, according to some embodiments. The BMS that serves building 10 is shown to include an HVAC system 100. In some embodiments, HVAC system 100 represents a commercial HVAC system. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

As shown, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

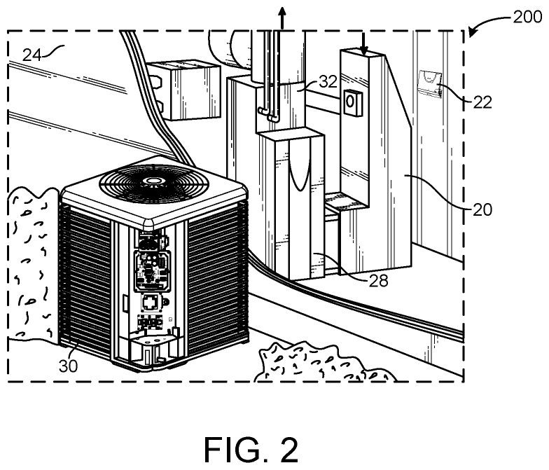

Referring now to FIG. 2, a residential building having a heating, ventilation, and air conditioning (HVAC) system 200 is shown, according to some embodiments. Generally, HVAC system 200 may provide heated and/or cooled air to a residential structure, although in some embodiments, HVAC system 200 can be utilized as part of a commercial HVAC system (e.g., as part of roof top units), as described above with reference to FIG. 1. In general, a residence 24 includes refrigerant conduits that operatively couple an indoor unit 28 to an outdoor unit 30. Indoor unit 28 may be positioned in a utility space, an attic, a basement, and so forth. Outdoor unit 30 is situated adjacent to a side of residence 24. Refrigerant conduits transfer refrigerant between indoor unit 28 and outdoor unit 30, typically transferring primarily liquid refrigerant in one direction and primarily vaporized refrigerant in an opposite direction.

When HVAC system 200, is operating as an air conditioner, a coil in outdoor unit 30 serves as a condenser for re-condensing vaporized refrigerant flowing from indoor unit 28 to outdoor unit 30 via one of the refrigerant conduits. In these applications, a coil of the indoor unit 28, designated by the reference numeral 32, serves as an evaporator coil. Evaporator coil 32 receives liquid refrigerant (which may be expanded by an expansion device, not shown) and evaporates the refrigerant before returning it to outdoor unit 30.

Outdoor unit 30 draws in environmental air through its sides, forces the air through the outer unit coil using a fan, and expels the air. When operating as an air conditioner, the air is heated by the condenser coil within the outdoor unit 30 and exits the top of the unit at a temperature higher than it entered the sides. Air is blown over indoor coil 32 and is then circulated through residence 24 by means of ductwork 20, as indicated by the arrows entering and exiting ductwork 20. The overall HVAC system 200 operates to maintain a desired temperature as set by thermostat 22. When the temperature sensed inside the residence 24 is higher than the set point on the thermostat 22 (with the addition of a relatively small tolerance), the air conditioner will become operative to refrigerate additional air for circulation through the residence 24. When the temperature reaches the set point (with the removal of a relatively small tolerance), the unit can stop the refrigeration cycle temporarily.

In some embodiments, HVAC system 200 is configured so that the outdoor unit 30 is controlled to achieve a more elegant control over temperature and humidity within the residence 24. The outdoor unit 30 is controlled to operate components within the outdoor unit 30, and HVAC system 200, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

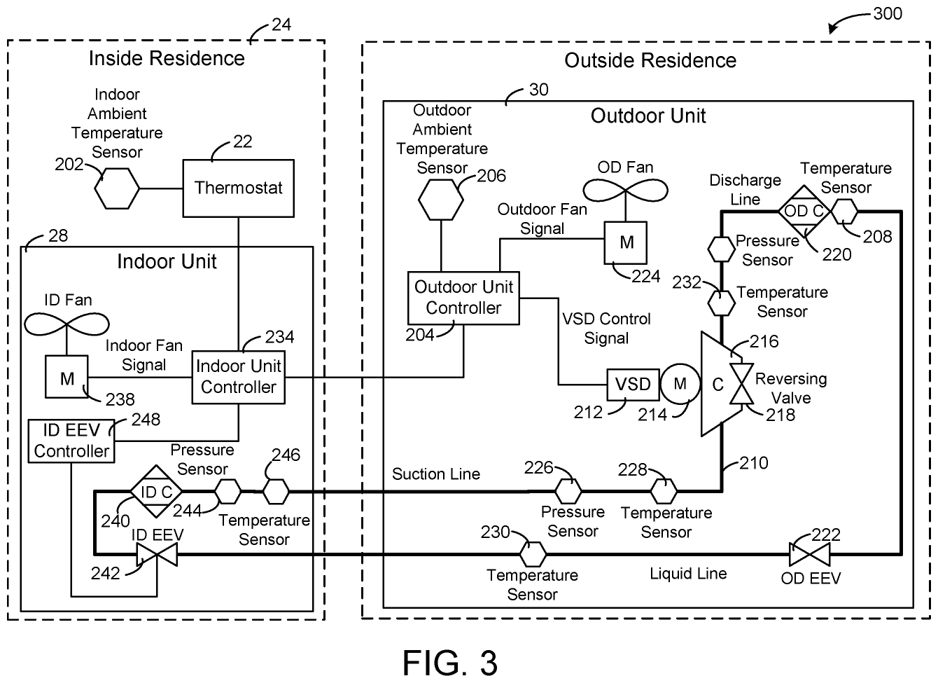

Referring now to FIG. 3, a detailed diagram of HVAC system 200 is shown, according to some embodiments. Various components of HVAC system 200 may be located inside residence 24 while other components are located outside of residence 24. Outdoor unit 30, as described with reference to FIG. 2, is shown to be located outside residence 24 while indoor unit 28 and thermostat 22, as described with reference to FIG. 2, are shown to be located inside the residence 24. In various embodiments, the thermostat 22 can cause the indoor unit 28 and the outdoor unit 30 to heat residence 24. In some embodiments, the thermostat 22 can cause the indoor unit 28 and the outdoor unit 30 to cool the residence 24. In other embodiments, the thermostat 22 can command an airflow change within the residence 24 to adjust the humidity within the residence 24.

Thermostat 22 is configured to generate control signals for indoor unit 28 and/or outdoor unit 30. The thermostat 22 is shown to be connected to an indoor ambient temperature sensor 202, and an outdoor unit controller 204 is shown to be connected to an outdoor ambient temperature sensor 206. The indoor ambient temperature sensor 202 and the outdoor ambient temperature sensor 206 may be any kind of temperature sensor (e.g., thermistor, thermocouple, etc.). The thermostat 22 may measure the temperature of residence 24 via the indoor ambient temperature sensor 202. Further, the thermostat 22 is configured to receive the temperature outside residence 24 via communication with the outdoor unit controller 204. In various embodiments, the thermostat 22 generates control signals for the indoor unit 28 and the outdoor unit 30 based on the indoor ambient temperature (e.g., measured via indoor ambient temperature sensor 202), the outdoor temperature (e.g., measured via the outdoor ambient temperature sensor 206), and/or a temperature set point. The thermostat 22 may include one or more PCBs, an enclosure, a touch screen, buttons, and/or any other thermostat component.

The indoor unit 28 and the outdoor unit 30 may be electrically connected. Further, indoor unit 28 and outdoor unit 30 may be coupled via conduits 210. The outdoor unit 30 is configured to compress refrigerant inside conduits 210 to either heat or cool the building based on the operating mode of the indoor unit 28 and the outdoor unit 30 (e.g., heat pump operation or air conditioning operation). The refrigerant inside conduits 210 may be any fluid that absorbs and extracts heat. For example, the refrigerant may be hydro fluorocarbon (HFC) based R-410A, R-407C, and/or R-134a.

The outdoor unit 30 is shown to include the outdoor unit controller 204, a variable speed drive 212, a motor 214 and a compressor 216. The outdoor unit 30 is configured to control the compressor 216 and to further cause the compressor 216 to compress the refrigerant inside conduits 210. In this regard, the compressor 216 may be driven by the variable speed drive 212 and the motor 214. For example, the outdoor unit controller 204 can generate control signals for the variable speed drive 212. The variable speed drive 212 (e.g., an inverter, a variable frequency drive, etc.) may be an AC-AC inverter, a DC-AC inverter, and/or any other type of inverter. The variable speed drive 212 is configured to vary the torque and/or speed of the motor 214 which in turn drives the speed and/or torque of compressor 216. The compressor 216 may be any suitable compressor such as a screw compressor, a reciprocating compressor, a rotary compressor, a swing link compressor, a scroll compressor, or a turbine compressor, etc.

In some embodiments, the outdoor unit controller 204 is configured to process data received from the thermostat 22 to determine operating values for components of the system 100, such as the compressor 216. In one embodiment, the outdoor unit controller 204 is configured to provide the determined operating values for the compressor 216 to the variable speed drive 212, which controls a speed of the compressor 216. The outdoor unit controller 204 is controlled to operate components within the outdoor unit 30, and the indoor unit 28, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 204 can control a reversing valve 218 for operating HVAC system 200 as a heat pump or an air conditioner. For example, the outdoor unit controller 204 may cause reversing valve 218 to direct compressed refrigerant to the indoor coil 32 while in heat pump mode and to an outdoor coil 220 while in air conditioner mode. In this regard, the indoor coil 32 and the outdoor coil 220 can both act as condensers and evaporators depending on the operating mode (i.e., heat pump or air conditioner) of system 200.

Further, in various embodiments, outdoor unit controller 204 is configured to control and/or receive data from an outdoor electronic expansion valve (EEV) 222. The outdoor electronic expansion valve 222 may be an expansion valve controlled by a stepper motor. In this regard, the outdoor unit controller 204 is configured to generate a step signal (e.g., a PWM signal) for the outdoor electronic expansion valve 222. Based on the step signal, the outdoor electronic expansion valve 222 can be held fully open, fully closed, partial open, etc. In various embodiments, the outdoor unit controller 204 is configured to generate step signal for the outdoor electronic expansion valve 222 based on a subcool and/or superheat value calculated from various temperatures and pressures measured in system 200. In one embodiment, the outdoor unit controller 204 is configured to control the position of the outdoor electronic expansion valve 222 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 204 is configured to control and/or power an outdoor fan 224. The outdoor fan 224 is configured to blow air over the outdoor coil 220. In this regard, the outdoor unit controller 204 can control the amount of air blowing over the outdoor coil 220 by generating control signals to control the speed and/or torque of outdoor fan 224. In some embodiments, the control signals are pulse wave modulated signals (PWM), analog voltage signals (i.e., varying the amplitude of a DC or AC signal), and/or any other type of signal. In one embodiment, the outdoor unit controller 204 can control an operating value of the outdoor fan 224, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 30 may include one or more temperature sensors and one or more pressure sensors. The temperature sensors and pressure sensors may be electrical connected (i.e., via wires, via wireless communication, etc.) to the outdoor unit controller 204. In this regard, the outdoor unit controller 204 is configured to measure and store the temperatures and pressures of the refrigerant at various locations of the conduits 210. The pressure sensors may be any kind of transducer that is configured to sense the pressure of the refrigerant in the conduits 210. The outdoor unit 30 is shown to include pressure sensor 226. The pressure sensor 226 may measure the pressure of the refrigerant in conduits 210 in the suction line (i.e., a predefined distance from the inlet of compressor 216. Further, the outdoor unit 30 is shown to include pressure sensor 226. The pressure sensor 226 may be configured to measure the pressure of the refrigerant in conduits 210 on the discharge line (e.g., a predefined distance from the outlet of compressor 216).

The temperature sensors of outdoor unit 30 may include thermistors, thermocouples, and/or any other temperature sensing device. The outdoor unit 30 is shown to include temperature sensor 208, temperature sensor 228, temperature sensor 230, and temperature sensor 232. The temperature sensors (i.e., temperature sensor 208, temperature sensor 228, temperature sensor 230, and/or temperature sensor 232) are configured to measure the temperature of the refrigerant at various locations inside conduits 210.

In FIG. 3, the indoor unit 28, the indoor unit 28 is shown to include indoor unit controller 234, indoor electronic expansion valve controller 236, an indoor fan 238, an indoor coil 240, an indoor electronic expansion valve 242, a pressure sensor 244, and a temperature sensor 246. The indoor unit controller 234 is configured to generate control signals for indoor electronic expansion valve controller 248. The signals may be set points (e.g., temperature set point, pressure set point, superheat set point, subcool set point, step value set point, etc.). In this regard, indoor electronic expansion valve controller 248 is configured to generate control signals for indoor electronic expansion valve 242. In various embodiments, indoor electronic expansion valve 242 may be the same type of valve as outdoor electronic expansion valve 222. In this regard, indoor electronic expansion valve controller 248 is configured to generate a step control signal (e.g., a PWM wave) for controlling the stepper motor of the indoor electronic expansion valve 242. In this regard, indoor electronic expansion valve controller 248 is configured to fully open, fully close, or partially close the indoor electronic expansion valve 242 based on the step signal.

Indoor unit controller 234 is configured to control an indoor fan 238. The indoor fan 238 is configured to blow air over indoor coil 32. In this regard, the indoor unit controller 234 can control the amount of air blowing over the indoor coil 240 by generating control signals to control the speed and/or torque of the indoor fan 238. In some embodiments, the control signals are pulse wave modulated signals (PWM), analog voltage signals (i.e., varying the amplitude of a DC or AC signal), and/or any other type of signal. In one embodiment, the indoor unit controller 234 may receive a signal from the outdoor unit controller indicating one or more operating values, such as speed for the indoor fan 238. In one embodiment, the operating value associated with the indoor fan 238 is an airflow, such as cubic feet per minute (CFM). In one embodiment, the outdoor unit controller 204 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 234 may be electrically connected (e.g., wired connection, wireless connection, etc.) to pressure sensor 244 and/or temperature sensor 246. In this regard, the indoor unit controller 234 can take pressure and/or temperature sensing measurements via pressure sensor 244 and/or temperature sensor 246. In one embodiment, pressure sensor 244 and temperature sensor 246 are located on the suction line (i.e., a predefined distance from indoor coil 32). In other embodiments, the pressure sensor 244 and/or the temperature sensor 246 may be located on the liquid line (i.e., a predefined distance from indoor coil 32).

### Thermostat for Commercial or Residential HVAC Systems

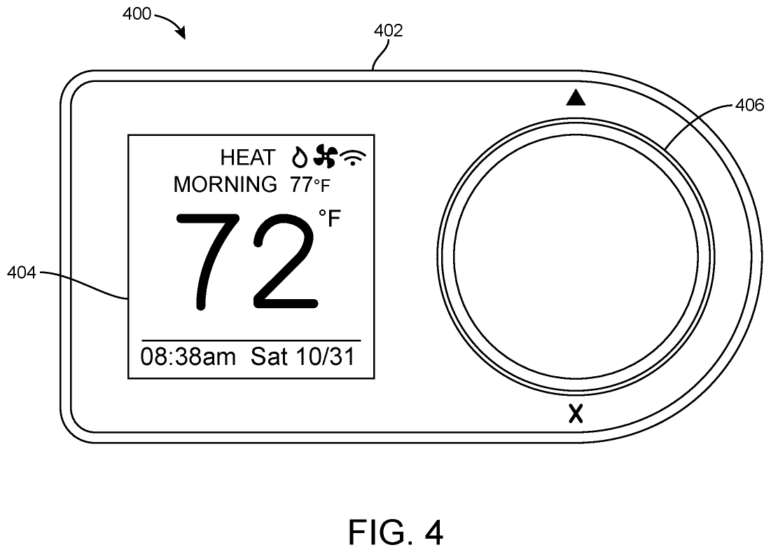

Referring now to FIG. 4, a drawing of a thermostat 400 is shown, according to some embodiments. Generally, thermostat 400 can control one or more building devices capable of affecting an indoor air temperature of a building having a commercial or residential HVAC system. Thermostat 400 may be used to control the equipment of HVAC systems 100 or 200, described above with respect to FIG. 1-3, for example. More specifically, thermostat 400 may be represented by thermostat 22 in FIGS. 2 and 3. As described herein, thermostat 400 is generally powered by one or more batteries or other portable power sources.

As shown, thermostat 400 includes a housing 402. Housing 402 may be constructed of any suitable material (e.g., plastic) and may provide a method of securing thermostat 400 to a wall or other mounting surface. Housing 402 may enclose at least a portion of the components of thermostat 400. Generally, housing 402 encloses one or more printed circuit boards (PCBs), controllers, sensors, or other devices for monitoring and controlling building equipment (e.g., HVAC equipment). For example, housing 402 may include processing circuitry (e.g., one or more processors or memory), a network interface, temperature sensors, or any other component. In some embodiments, housing 402 at least partially encloses user interface components, including a user interface 404 and an input device 406. In other embodiments, user interface 404 and input device 406 and not enclosed by housing 402, but are included in thermostat 400.

In some embodiments, a user may interact with thermostat 400 via input device 406. A user may use input device 406 to change a setting or parameter, enter a temperature setpoint, change an operating mode, or otherwise interact with thermostat 400, for example. In some such embodiments, user interface 404 may present a variety of information to the user, such as a current time and/or date, a current temperature, a temperature setpoint, a mode, or any other information regarding thermostat 400 and/or building HVAC equipment. As an example, thermostat 400 may measure an ambient room temperature and display the ambient room temperature to a user. In this example, a user may input a temperature setpoint via input device 406 and, based on the temperature setpoint and the current ambient temperature, thermostat 400 may cause building equipment to either heat or cool the building.

User interface 404 is generally any type of electronic display configured to present information to a user in a visual format (e.g., as text, graphics, etc.). The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoS), or any other display technologies known in the art. In some embodiments, the user interface 404 is configured to present visual media (e.g., text, graphics, etc.) without requiring a backlight.

In other embodiments, user interface 404 is an interactive display that can present information to a user and/or receive input from the user. For example, user interface 404 may include a touch-sensitive panel layered on top of an electronic visual display. A user can provide inputs through simple or multi-touch gestures, such as by touching user interface 404 with one or more fingers and/or with a stylus or pen. In some such embodiments, thermostat 400 may not include input device 406. User interface 404 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of user interface 404 allowing registration of touch in two or even more locations at once.

In some embodiments, thermostat 400 may include an interface for communicating with a network. The interface may include, for example, a wireless connection (e.g., WiFi, cellular, WAN, Bluetooth, etc.) or a wired connection (e.g., Ethernet). The interface may provide means for thermostat 400 to communicate with other devices (e.g., a server, other thermostats, a user device, etc.) via an internet or intranet network. As an example, thermostat 400 may be an internet-of-things (IoT) enable device, such as in a smart home implementation. In this example, thermostat 400 may include an IoT-optimized WiFi module for wirelessly communicating with the Internet via a home network or router.

In some embodiments, where thermostat 400 is IoT enabled, a user may interact with thermostat 400 via a remote device. For example, a user may control thermostat 400 via a smartphone application. In this example, the user may be presented with a graphical user interface (GUI) via a mobile phone, and the user may interact with the GUI to enter or change parameters of thermostat 400. A user may change a temperature setpoint or an operating mode of thermostat 400 for example. An IoT enabled thermostat such as thermostat 400 may also receive data/inputs from third party services. For example, thermostat 400 may receive weather information from a weather service, or may receive user inputs from a third-party device (e.g., Amazon Alexa™, Google Assistant™, etc.).

As described above, battery-powered IoT devices, such as thermostat 400, may face particular challenges due to the limited amount of energy provided by a battery or other portable energy source. For example, a battery-power thermostat unit may operate for a finite time period (e.g., one week, one month) before requiring a change of batteries or a recharge. Therefore, it may be beneficial to prolong the time period during which thermostat 400 can operate without requiring new batteries or recharging. Such a solution would increase the effectiveness of thermostat 400 by reducing the amount of manual effort or maintenance required by a user of thermostat 400.

To help extend operational time between battery changes or recharging, thermostat 400 may generally operate in either an operational (i.e., run) state or a power-saving state. In the operational state, thermostat 400 may be awake and may communicate with a network and/or control HVAC equipment. In the power-saving state, thermostat 400 may reduce power consumption by sleeping, where thermostat does not communicate with the network. In some embodiments, user interface 404 may shut off to further conserve power.

### Power Saving Communications System

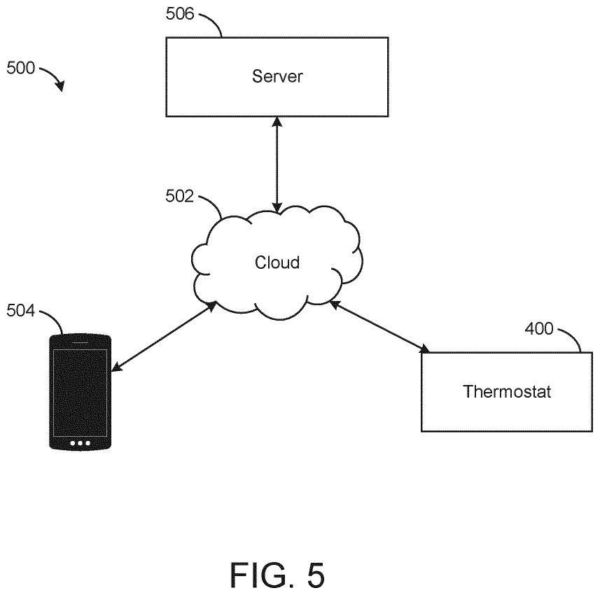

Referring now to FIG. 5, a power saving communications system 500 is shown, according to some embodiments. System 500 may be a communication system for receiving, processing, storing, and/or implementing user inputs to a HVAC system. As an example, a user input to a user device 504 may be received and/or processed by a server 506 before being transmitted to thermostat 400. System 500 may, advantageously, reduce a power consumption of a user input device (e.g., a thermostat) of the HVAC system by the methods described herein.

As shown, system 500 may be at least partially implemented via a cloud 502. Cloud 502 may be a network configured to interface (i.e., communicably couple) user device 504, server 506, and/or thermostat 400. Cloud 502 may be a local network (i.e., intranet) of a building, for example, or may be a remote network (i.e., internet) such the Internet. In some embodiments, system 500 maybe at least partially implemented via another type of network, cloud, internet or intranet, or by another type of network or web service. In various embodiments, communications via cloud 502 can be direct (e.g., local wired or wireless communications) or via a communications network (e.g., a WAN, the Internet, a cellular network, etc.).

User device 504 may be any electronic device that allows a user to interact with system 500, such as through a user interface. For example, user device 504 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with system 500, its subsystems, and/or other devices. User device 504 may be a computer workstation, a client terminal, a remote or local interface, or any other type of user interface device. User device 504 can be a stationary terminal or a mobile device. For example, user device 504 can be a desktop computer, a computer server with a user interface, a laptop computer, a tablet, a smartphone, a PDA, or any other type of mobile or non-mobile device. User device 504 can communicate with server 506 and/or thermostat 400 via cloud 502.

System 500 may help extend the time between battery changes or recharging of thermostat 400 may handling a portion of the processing required for inputs from user device 504. For example, server 506, described in detail below, may process inputs from user device 504 while thermostat 400 is in a power-saving state. More specifically, an input to user device 504 may be transmitted to server 506 via cloud 502, where server 506 processes and stores the input. As another example, a user may enter a new temperature setpoint for thermostat 400 via user device 504, and the user input of the temperature setpoint may subsequently be transmitted to server 506 for processing and/or storage. In some embodiments, data from thermostat 400 may be transmitted to server 506 for processing and/or validation before being transferred to user device 504.

In some embodiments, data is communicated between server 506, user device 504, and/or thermostat 400 according to hypertext transfer protocol secure (HTTPS). HTTPS is a secure version of HTTP utilizing transport layer security (TLS), therefore, communications between server 506, user device 504, and/or thermostat 400 may be secure. Additionally, HTTPS may be a preferred communication protocol for use in a power saving communications system, such as system 500, due to its response-request nature. Unlike other protocols used in may IoT communications (e.g., MQTT), HTTPS does not require an “always active” communication path (e.g., constant communication between an IoT device and a network). Instead, communications utilizing HTTPS, such as the connection between server 506 and thermostat 400, are only active during the transmission of data. In this way, utilizing HTTPS to transmit and receive data from, to, or within system 500 may help reduce the energy consumption of thermostat 400 by allowing thermostat 400 to enter a power-saving state where thermostat 400 is not supporting an active communication path and/or regularly or constantly transmitting data or monitoring the communication path.

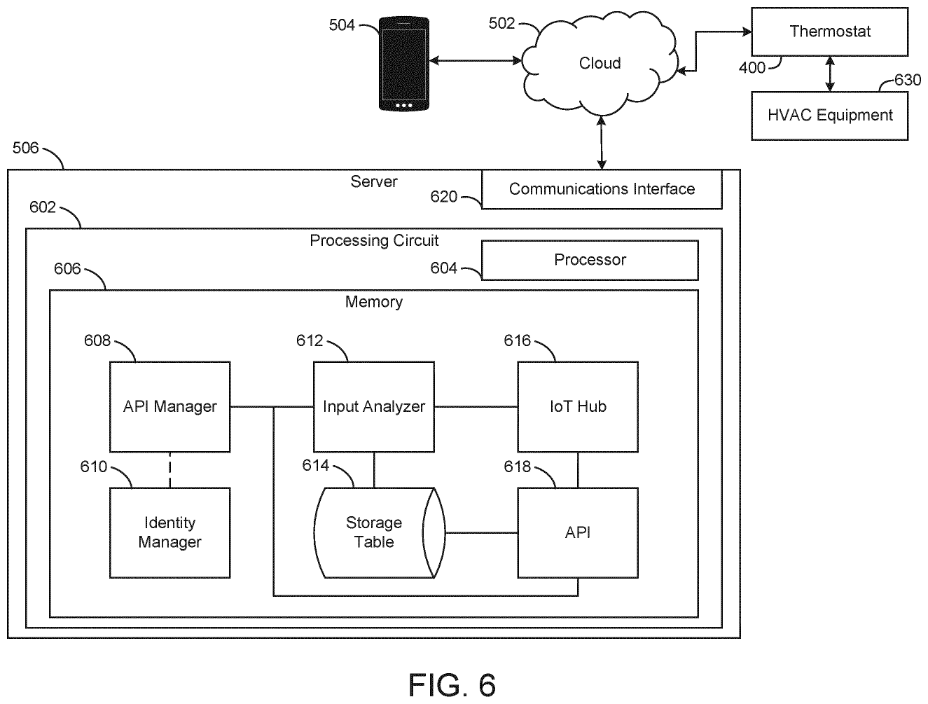

Referring now to FIG. 6, server 506 of system 500 is shown in greater detail, according to some embodiments. Server 506 can be implemented in a variety of ways. In some embodiments, server 506 is implemented within a single computer (e.g., one server, one housing, etc.). In various other embodiments, server 506 can be distributed across multiple servers or computers (e.g., that can exist in distributed locations). As an example, server 506 may be implemented using one or more on-premises server computers and/or one or more remote cloud-based server computers. In this sense, server 506 may be distributed across a variety of physical hardware devices. In some embodiments, server 506 may be a network device such as a network engine. Server 506 may also be a workstation, personal computer or another type of device similar to user device 504 with server software installed thereon.

Server 506 is shown to include a processing circuit 602 that includes a processor 604 and a memory 606. It will be appreciated that these components can be implemented using a variety of different types and quantities of processors and memory. Processing circuit 602 can be communicably connected to a communications interface 620 such that processing circuit 602 and the various components thereof can send and receive data via communications interface 620. Processor 604 can be implemented as a general purpose processor, an application specific integrated circuit (ASIC), one or more field programmable gate arrays (FPGAs), a group of processing components, or other suitable electronic processing components.

Memory 606 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 606 can be or include volatile memory or non-volatile memory. Memory 606 can include database components, object code components, script components, or any other type of information structure for supporting the various activities and information structures described in the present application. According to an example embodiment, memory 606 is communicably connected to processor 604 via processing circuit 602 and includes computer code for executing (e.g., by processing circuit 602 and/or processor 604) one or more processes described herein.

Still referring to FIG. 6, memory 606 is shown to further include an application programming interface (API) manager 608. Generally, API manager 608 is a gateway (i.e., a front-end) to one or more other components of memory 606. API manager 608 may be configured to perform a number of functions, such as receiving inputs (i.e., API requests), enforcing security policies, transmitting input data to back-end services (e.g., APIs), and/or transmitting data from back-end services to external systems (e.g., user device 504, thermostat 400, etc.). For example, API manager 608 may receive an input (e.g., from user device 504 via communications interface 620), validate the input, and transmit the input to an input analyzer 612. In general, the inputs received by API manager 608 may be changes to one or more parameters of thermostat 400, such as a temperature setpoint, an operating mode, weather data, a schedule, etc.

In some embodiments, an identity manager 610 may receive or request credentials from user device 504 prior to, or concurrently with, API manager 608 receiving an input. Credentials may include, for example, login information corresponding to a user (e.g., a user name, a user ID, a password, etc.), identification information associated with a third-party system (e.g., an online weather service), and/or identification information corresponding to user device 504 (e.g., a token, a certificate, etc.). Identity manager 610 may validate a user device (e.g., user device 504) and/or an input based on any number of received credentials. In various embodiments, user device 504 and/or a user of user device 504 may be authenticated once (e.g., during registration of the user and/or user device 504) or multiple times (e.g., with each login attempt, with each user input).

In some embodiments, user device 504 is authenticated during a registration process. In such embodiments, information associated with user device 504 and/or a user of the user device may be validated and/or stored for future reference. For example, during a registration process, a user of user device 504 may input credentials (i.e., login information), such as a user name or ID, and a password. Said credentials may be transmitted, along with user device information (e.g., a token, an IP address, a device location, etc.), to identity manager 610. In this example, identity manager 610 may authenticate the user and/or user device 504 by comparing the received credentials and device information to a database of allowed or previously authenticated users. In another example, identity manager 610 may register the user and/or user device 504 by storing the authentication information, a copy of the information, or another reference in a database. In this way, identity manager 610 may reference the previously stored information during subsequent login attempts by the user and/or user device 504.

In one example, a user of user device 504 may enter a user ID and a password in order to access a user interface for inputting a parameters, such as a temperature setpoint. In this example, the user credentials may be validated by identity manager 610 prior to the new temperature setpoint being processed by API manager 608 and/or transmitted to input analyzer 612. In another example, a third-party weather service may transmit an updated weather data (e.g., corresponding to a geographical location of thermostat 400) and credentials associated with the weather service (e.g., a token or certificate) may be verified before transmitting the weather data to input analyzer 612. In some embodiments, identity manager 610 (e.g., in conjunction with API manager 608) may validate an input by determining whether the input was received from an authorized user device or user. As yet another example, a received input may include an identifier (e.g., a token, a certificate, etc.) associated with a user device that transmitted the input. In this example, the identifier may be validated by API manager 608.

After a user input has been validated (e.g., by API manager 608 in conjunction with identity manager 610), API manager 608 may further process the user input, such as by converting the input to another format. API manager 608 may convert an input (i.e., user input data) to a suitable format for input analyzer 612, for example. More generally, API manager 608 may receive data in a first format and convert the data to a second format before transmitting the data to another component. In some embodiments, API manager 608 may also provide caching and/or collect analytical data regarding received inputs.

API manager 608 may transmit validated input data to input analyzer 612 for further processing. In some embodiments, input analyzer 612 applies a timestamp to any received data. The timestamp may indicate a time when the data (i.e., input) was received. In some embodiments, input analyzer 612 may determine whether an input was received within a particular time period based on the operating schedule of thermostat 400, as described above. In one example, inputs may only be valid if received prior to five minutes from a state change (e.g., five minutes from thermostat 400 waking). In this example, an input received at seven minutes from a scheduled state change may be valid, and an input received at three minutes from the scheduled state change may be invalid.

In some embodiments, valid input data may be stored in a storage table 614 and/or transmitted to an internet-of-things (IoT) hub 616. Storage table 614 is generally a component of memory 606, such as a partitioned area of memory 606 for example, configured to store structured, unstructured, or semi-structured data. In some embodiments, storage table 614 may store preprocessed input data indicating a parameter change for thermostat 400 (e.g., such as operating mode changes, weather data, temperature setpoints, schedules, etc.). Storage table 614 generally stores said data along with the timestamp assigned by input analyzer 612.

IoT hub 616 may receive data from input analyzer 612 for further logging or processing, such as by an analytical engine. In this manner, IoT hub 616 may provide a means for monitoring overall system analytics (e.g., by a dashboard or interface of the analytical engine). In some embodiments, IoT hub 616 may aggregate data for multiple thermostats (e.g., multiple of thermostat 400). In such embodiments, the data aggregated by IoT hub 616 may be provided to a user device for high-level system monitoring. For example, an owner of an apartment complex may wish to monitor data associated with one or more thermostats, each located in a particular unit of the complex. In this example, IoT hub 616 may aggregate data from the one or more thermostats and present the aggregated data to the owner, such as in a management software. As another example, IoT hub 616 may generate a list of inputs (i.e., data, messages) and their corresponding timestamps based on data stored in storage table 614. This may allow a user of an analytical engine dashboard to view current or historical inputs. In some embodiments, IoT hub 616 may provide means for connecting or monitoring a plurality of IoT enabled devices, including thermostat units and other types of IoT devices.

Still referring to FIG. 6, memory 606 is shown to include an API 618. API 618 is generally an interface between server 506 and thermostat 400. In this regard, API 618 may implement parameter changes for thermostat 400 based on processed data (e.g., stored in storage table 614) and may communicate information associated with thermostat 400 to IoT hub 616. API 618 may communicate with IoT hub 616 according to an MQTT protocol. In other embodiments, API 618 communicates with IoT hub 616 by simulating an MQTT protocol.

API 618 is generally configured to retrieve messages (e.g., data associated with individual inputs) stored in storage table 614. API 618 may further identify a number of remaining messages stored in storage table 614. API 618 may transmit a first message and/or an indication of the number of remaining messages to thermostat 400. As described above, each message transmitted by API 618 may be a parameter change associated with thermostat 400 and received from a user device or a third-party service. For example, the first message transmitted by API 618 to thermostat 400 may include a temperature setpoint, a mode change, a schedule, weather data, or other relevant data.

In some embodiments, data transmitted by API 618 may be post-processed or otherwise validated by API manager 608 before being transmitted to thermostat 400. For example, API manager 608 may validate the output data or convert the output data to a new format as required by thermostat 400. Likewise, in some embodiments, data from thermostat 400 (e.g., an indication of current parameters of the thermostat unit) may be validated by API manager 608 before being routed to API 618. As an example, thermostat 400 may transmit a notification when entering the operational state (i.e., upon wake-up). This notification may be received by API manager 608, validated, and transmitted to API 618. In some embodiments, data from thermostat 400 may be validated in a similar manager to data received from user device 504, where the data is only valid from an authorized thermostat unit. In such embodiments, thermostat 400 may authenticate itself, such as by transmitting a token, certificate, etc., along with any data.

In some embodiments, API 618 first receives a notification from thermostat 400 when thermostat 400 enters the operational state (i.e., wakes up). In some such embodiments, the notification may include operational data associated with thermostat 400. For example, thermostat 400 may transmit a notification of the state change (e.g., to the operational state) along with current temperature setpoints, modes, schedules, etc. Current operational data received from thermostat 400 may be associated with inputs (e.g., from a user) made directly to thermostat 400, such as by interacting with thermostat 400 via interface 404 and input device 406. For example, a user may interact with thermostat 400 by entering a temperature setpoint using input device 406. The temperature setpoint may be received while thermostat 400 is in a power-saving mode (e.g., not communicating with cloud 502), thus the temperature setpoint may transmitted to API 618 along with the notification.

Upon receiving said notification, API 618 may retrieve a first message from the stored data in storage table 614. Generally, API 618 retrieves the earliest message (e.g., with the earliest timestamp) first, and subsequently transmit the first message to thermostat 400. API 618 may transmit, along with or separate from the first message, an indication of the number of messages (i.e., data, packets) left to be transmitted. Assuming that messages remain in storage table 614, API 618 may continue to retrieve messages (e.g., a second message, a third message, etc.) and subsequently transmit the message, along with the indication of remaining messages, to thermostat 400.

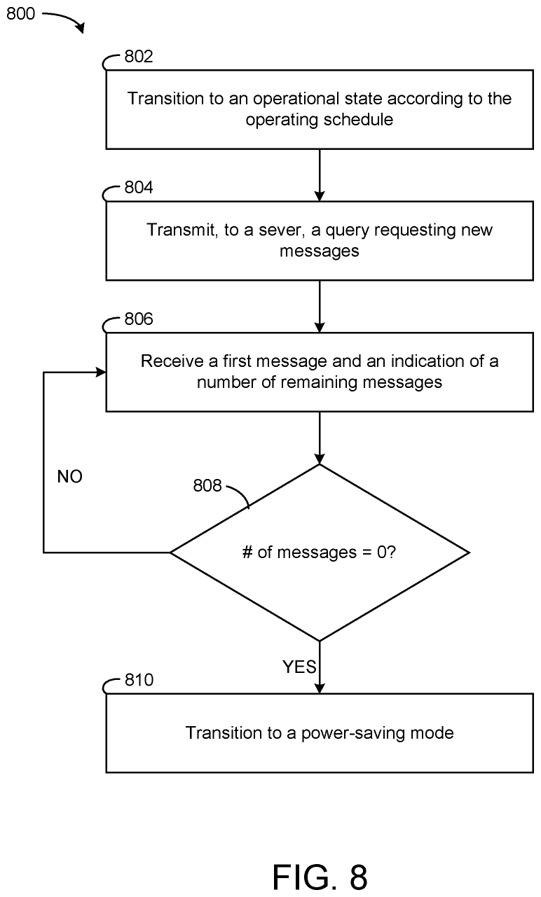

In some embodiments, prior to transmitting a message to thermostat 400, the message is generated by API 618 by merging data received from thermostat 400 with data retrieved from storage table 614. As an example, a message may be retrieved from storage table 614 that indicates a temperature setpoint and mode change (e.g., “set thermostat to home mode cool and set temperature to 64° F.”) which may be compared to a message received from thermostat 400 indicating a separate and/or different temperature setpoint and mode change (e.g., “set thermostat to home mode cool and set temperature to 70° F.”). In this example, the message received from thermostat 400 may override the message retrieved from storage table 614. Accordingly, rather than transmit the message retrieved from storage table 614, API 618 may store the message received from thermostat 400 (e.g., in storage table 614). The merge operations are described in detail below with respect to FIG. 8.

Upon receiving a message, or upon receiving an indication that there are no remaining message, thermostat 400 may implement one or more parameter changes associated with the received messages. For example, thermostat 400 may update weather data, or may control HVAC equipment 630 based on a received temperature setpoint, schedule, mode change, etc. HVAC equipment 630 generally includes any of the HVAC equipment described above, such as the HVAC equipment described with respect to FIGS. 1-3 (e.g., outdoor unit 30, indoor unit 28, etc.). After thermostat 400 has implemented any received parameter changes and/or received the indication that there are no remaining messages, thermostat 400 may transition to a power-saving (i.e., sleep) state.

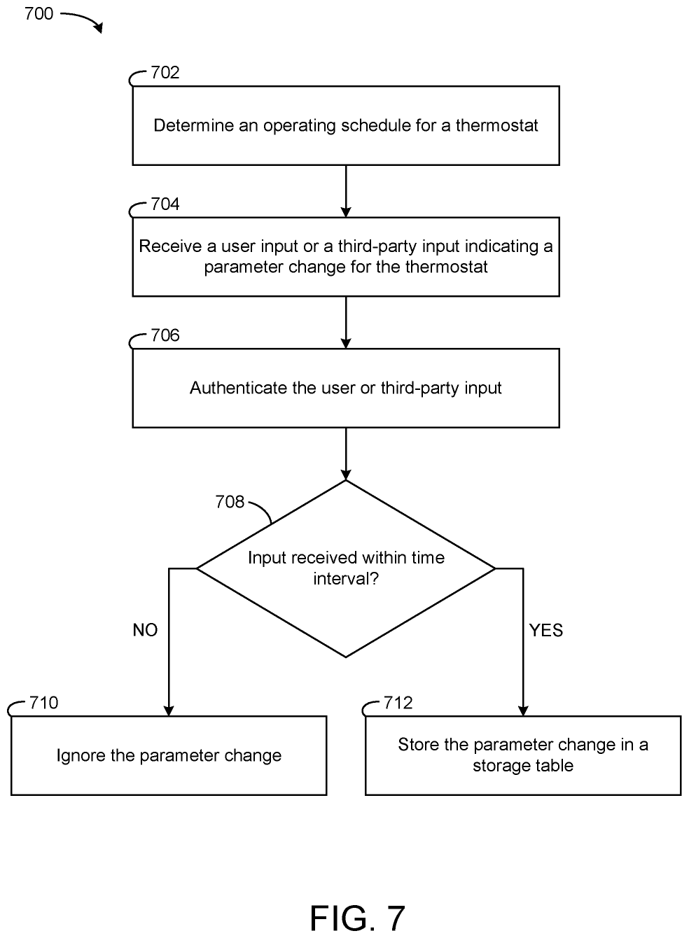

Referring now to FIG. 7, a process 700 for processing an input to a power saving communications circuit is shown, according to some embodiments. Process 700 generally describes a process for receiving, authenticating, and storing an input from a user device or a third-party service. In some embodiments, process 700 may be implemented by server 506. In some such embodiments, process 700 may be performed by server 506 while thermostat 400 is in a power-saving state.

At step 702, an operating schedule for a thermostat unit (e.g., thermostat 400) is determined. The operating schedule may include a time interval that indicates how often the thermostat unit wakes (e.g., enters the operation state). The time interval for the operating schedule may be any length of time (e.g., once a day, once an hour, etc.). In some embodiments, the operating schedule may be received via a user input. In other embodiments, the operating schedule may be predetermined (e.g., preprogrammed or set at manufacture). As an example, a user may input an operating schedule where a thermostat unit wakes every 15 minutes to check for new messages (i.e., data, inputs), or the thermostat unit may be programmed from a manufacturer to wake every two hours to check for messages. Generally, less frequent transitions may increase the battery life of the thermostat unit.

At step 704, an input is received from a user device or a third-party. In some embodiments, the input is received by API manager 608 via communications interface 620. Generally, the input indicates a parameter change for the thermostat unit. For example, the input may indicate a temperature setpoint, an operating mode (e.g., heating, cooling), a schedule (e.g., temperature setpoints associated with particular times and/or days of the week), weather data (e.g., for a geographical location associated with the thermostat unit), etc. In various embodiments, the user input is received from a user device (e.g., user device 504) such as a mobile phone, a computer, a smart speaker, etc., or a third-party device or service such as via a virtual assistant, a weather service, etc. As an example, a user may input a desired temperature setpoint via a smartphone app. In another example, an input may be received (e.g., via an internet connection) from an online weather service.

At step 706, the input may be authenticated. In some embodiments, the input may be authenticated by API manager 608 in conjunction with identity manager 610. As described above with respect to FIG. 6, the input may be authenticated based on a user device or a third-party service associated with the input. Authentication may include comparing credentials (e.g., tokens, certificates, user IDs, passwords, etc.) associated with the user device or the third-party service that transmitted the input to previously registered, previously authenticated, or otherwise known-safe devices or services. In some embodiments, the input may include an identifier, such as a token, associated with a known user device or third-party service, and the input may be authenticated based on the included identifier.

At step 708, a determination is made as to whether the input was received within a particular time interval. In some embodiments, the determination made at step 708 is performed by input analyzer 612. In some embodiments, a time interval may be set, determined, or identified based on the operating schedule determined at step 702. In other embodiments, the time interval may be a parameter of the thermostat unit that cannot be set or changed. The time interval may indicate a period of time where inputs (e.g., from a user device or third-party service) are permitted and/or valid. For example, an input may only be valid if received prior to five minutes from a schedule state change for the thermostat unit (i.e., waking or transitioning to the operational state from the power-saving state). In this example, if the operating schedule (e.g., determined at step 702) indicates that the thermostat unit should wake every 15 minutes, then inputs may only be valid if received in a 10 minute time interval from when the thermostat unit transitions to the power-saving state (i.e., sleeps). More generally, inputs may only be valid within a particular time period from the thermostat unit transitioning to the sleep state.

In the case where an input is not received within the time interval, the input (e.g., and associated parameter change) may be ignored (step 710). As in the previous example, if the time interval indicates that inputs are invalid if received within five minutes of a scheduled state transition (i.e., after 10 minutes from the thermostat unit entering the sleep state), an input received three minutes from a schedule transition (i.e., at 13 minutes) to the operational state (e.g., wake-up) may be invalid and, therefore, ignored. However, if the input is received within the time interval, the input (e.g., and associated parameter change) may be stored in a storage table (e.g., storage table 614) (step 710). To continue the previous example, if the time interval indicates that inputs are valid if received between the thermostat unit transitioning to the power-saving state and five minutes from a scheduled state transition to the operational state, an input received one minute after the thermostat unit transitioning to the sleep state (i.e., at 1 minute) may be valid and, therefore, stored in a storage table.

Referring now to FIG. 8, a process 800 for implementing a parameter change to a thermostat unit is shown, according to some embodiments. Process 800 may be implemented by thermostat 400 and facilitated by server 506, for example. Process 800 generally describes a process for updating one or more parameters of thermostat 400 based on stored user inputs (e.g., from step 714 of process 700).

In some embodiments, a thermostat unit (e.g., thermostat 400) may utilize less energy by implementing process 800 over other processes for updating thermostat parameters, which may be advantageous for certain applications (e.g., a battery powered thermostat). For example, certain processes may require a thermostat to be in constant or near-constant communication with a server or a controller in order to receive user inputs such as parameters changes. Such constant or near-constant communication, typical of IoT connected thermostats and other devices, may require a significant amount of energy.

In some embodiments, process 800 may occur subsequently to process 700, described above. Together, process 700 and process 800 may help to reduce an energy equipment for thermostat 400, thereby extending the battery life of thermostat 400, by providing a process for receiving and processing parameter change (i.e., inputs) while thermostat 400 sleeps. In this manner, thermostat 400 may require less energy to operate by only waking to communicate (e.g., send/receive messages) momentarily. Advantageously, increasing the battery life of thermostat 400 may decrease maintenance (e.g., battery replacement, charging), thereby increasing the effectiveness of thermostat 400. Therefore, thermostat 400 may provide users with the functionality of an IoT enabled thermostat with increased battery life.

At step 802, a thermostat unit (e.g., thermostat 400) transitions to an operational state (i.e., the thermostat unit wakes). In the operational state, the thermostat may be on (i.e., awake) and may be communicating with HVAC equipment (e.g., HVAC equipment 630) and/or a server (e.g., server 506). In some embodiments, the operational state is an operating state in which the thermostat communicates with a network (e.g., cloud 502) and/or a server (e.g., server 506). In some embodiments, the thermostat unit enters the operational state according to an operational schedule, such as the operational schedule determined at step 702 of process 700.

At step 804, responsive to entering the operational state, the thermostat unit may transmit a message (i.e., a query) to a server (e.g., server 506). The query may include a variety of operating data and parameters associated with the thermostat unit, such as current operating data and any user inputs received since the thermostat was last awake (e.g., communicating with the server). As an example, the query may include a current operating mode (e.g., heating, cooling), schedule, temperature setpoints, etc. In some embodiments, the message includes an inputs received and/or processed by the thermostat unit while the unit was offline (e.g., in the power-saving mode). For example, the thermostat unit may have received a new temperature setpoint from a user (e.g., a user interacting with thermostat 400 via input device 406). In this example, the thermostat unit may have implemented the new temperature setpoint locally (e.g., by operating HVAC equipment) and the query may include the new setpoint so that the server (e.g., a storage table of the server) may be updated with current thermostat unit parameters.

In some embodiments, the query transmitted by the thermostat further includes a request for the server to transmit, to the thermostat unit, any message received while the thermostat unit was offline (i.e., in the power-saving state). In this regard, the query may indicate that the thermostat unit is awake and ready to receive messages (i.e., data or inputs). In some embodiments, the query may simply indicate that the thermostat unit is awake, and the server may determine whether to send messages to the thermostat unit. In some embodiments, the query may be received by API manager 608 via communications interface 620, validated, and transmitted to API 618.

In some embodiments, after receiving the query from the thermostat unit, the server retrieves a first one of the plurality of messages stored in the storage table. The first retrieved message may be used to generate a first message to be sent to the thermostat unit by merging current operating data/parameters of the thermostat unit (e.g., the query) with the first retrieved message. For example, API 618 may receive a query from thermostat 400 and merge the query with messages stored in storage table 614 to generate subsequent messages for transmitting to thermostat 400. Merging the message received from the thermostat unit with stored messages may include comparing the stored messages with the query to determine whether one or more parameters included in the stored messages indicate a similar change to a parameter of the thermostat unit as the query.

In some embodiments, as described above, the query may indicate one or more parameters of the thermostat unit that were manually updated (e.g., directly, such as by an interface or input device of the thermostat unit) by a user of the thermostat unit while the unit was offline (i.e., in the power-saving mode). In such embodiments, the user inputs indicated in the query may be compared with the stored messages to determine whether to transmit the stored messages. For example, a first retrieved message may be compared to the query to determine if the first retrieved message and the query indicate a similar change to a parameter of the thermostat unit. In this example, the query may indicate that a user entered a temperature setpoint of 72° F. while the thermostat unit was in the power-saving mode, and the first retrieved message may indicate a temperature setpoint of 68° F. In this case, the query may override the first retrieved message. Subsequently, a second message may be retrieved from the storage table and merged with the query in the same manner.

In a non-limiting use case example, two message may be received from a user device (e.g., user device 504) and subsequently stored while the thermostat was in the power-saving mode. A first message may include a change to a thermostat mode (e.g., “Change mode to Home”) and a second message may include a change to a temperature setpoint (e.g., “Change cooling temperature setpoint to 64° F.”). When the thermostat unit wakes, the thermostat may transmit a message including a query and a user input of a parameter change received directly by the thermostat unit while it was offline (e.g., “Change cooling temperature setpoint to 68° F.”). The server (e.g., server 506) may subsequently compare the first and second message stored in the storage table to the message received from the thermostat unit. In this example, the first message (“Change mode to home”) may be processed and transmitted to the thermostat unit, as the unit had not received a mode change input while sleeping. The second message (“Change cooling temperature setpoint to 64° F.”) may be ignored, as the temperature setpoint processed directly by the thermostat unit (“Change cooling temperature setpoint to 68° F.”) overrides the second message received from a remote user (e.g., via user device 504).

In another non-limiting use case example, a first message may be received from a user device and subsequently stored while the thermostat was in the power-saving mode that includes a change to a thermostat mode (e.g., “Change mode to Home”) and a second message may be received that includes a change to a temperature setpoint (e.g., “Change cooling temperature setpoint to 64° F.”). When the thermostat unit wakes, the thermostat may transmit a message including a query and a user input of a parameter change received directly by the thermostat unit while it was offline (e.g., “Change heating temperature setpoint to 72° F.”). The server (e.g., server 506) may subsequently compare the first and second message stored in the storage table to the message received from the thermostat unit. In this example, both the first message (“Change mode to home”) and the second message (“Change cooling temperature setpoint to 64° F.”) may be processed and transmitted to the thermostat unit, as the thermostat unit had only received a heating temperature setpoint (“Change heating temperature setpoint to 72° F.”) while in the power-saving mode.

As described in the use case examples above, inputs directly to the thermostat unit (e.g., by a user with direct access to the physical unit) may override inputs received from a remote user (e.g., of user device 504). In some embodiments, the message transmitted by the thermostat unit may include parameters that are not included in any cloud messages. For example, a user may enter a heating temperature setpoint and the storage table may only have message associated with mode changes and cooling temperature setpoints. In such embodiments, the storage table may be updated with parameters received in the message from the thermostat unit. In some embodiments, where no parameter changes or updates are received from the thermostat unit (e.g., the message from the unit includes only the query), then all of the messages stored in the storage table may be processed and transmitted, one at a time, to the thermostat unit (e.g., at step 806).

At step 806, the thermostat unit receives a first message from the server. As described above, the first message may include parameters stored in the storage table and merged with the messaged received from the thermostat unit at step 804. The first message may include, for example, a state mode change (“Change mode to Home”), a temperature setpoint (“Change heating temperature setpoint to 72° F.”), a schedule, weather data (e.g., received from a third-party weather service), or any other relevant parameters and/or data. In some embodiments, the first message may also include an indication of a number of messages remaining to be sent. The indication may include an actual number of messages (e.g., “3 messages remaining”) or may include an indication (i.e., an acknowledgement) for the thermostat unit to request more messages.

As an example, the first message transmitted to the thermostat may include a parameter change (e.g., a temperature setpoint, a mode change, weather data, etc.) and an indication that four messages have yet to be sent (e.g., “Four messages remaining”). In this example, the indication includes the number of remaining messages may be sent separately from the first message. In another example, the first message may simply include a prompt or indication for the thermostat unit to request more messages (e.g., “Messages remaining”), or a lack of an acknowledgement may indicate that the thermostat unit has more messages to receive.

In some embodiments, each message may be a predetermined sized based on requirements of the thermostat unit. For example, the firmware of the thermostat unit may limit a message to 256 characters. In such embodiments, data (e.g., stored in storage table 614) may be split into multiple messages. For example, API 618 may split a single parameter change into two or more messages and send each message separately. However, limiting the size of a single message may further increase the battery life of a thermostat unit, as smaller messages (e.g., 256 characters or less) may require less energy to communicate.

At step 808, the thermostat unit determines whether there are any remaining messages to receive, as described briefly above. Based on a determination that there are remaining messages, step 806 may be repeated. In this case, a second message may be transmitted to the thermostat unit along with an indication of the number of remaining messages. As an example, thermostat 400 may receive a first message (e.g., from server 506) that includes a mode change (e.g., change from heating to cooling) and an indication that one message remains. Thermostat 400 may remain online (i.e., in the operational state) and may receive a second message (e.g., from server 506) along with an indication that no messages (i.e., zero messages) remain.

Once the thermostat unit receives an indication that there are no remaining messages, the thermostat unit may transition to a power-saving state (i.e., sleep). In other embodiments, the server may determine that no messages remain in the storage table and may send an indication to the thermostat unit. In some such embodiments, the indication may be an acknowledgement that all of the stored messages have been transmitted to the thermostat unit. Accordingly, no further communication between the thermostat unit and the server may be necessary.

In some embodiments, the thermostat unit may implement a parameter change associated with each received message as the messages are received. For example, the thermostat unit may receive a first message indicating a new temperature setpoint. The thermostat unit may control HVAC equipment (e.g., HVAC equipment 630) according to the new temperature setpoint immediately after receiving the first message. In other embodiments, the thermostat unit may implement a plurality of parameter changes upon receiving an indication that there are no remaining messages. For example, the thermostat unit may receive three messages in total, indicating a temperature setpoint, an operating mode change (e.g., to a cooling mode), and updated weather data. The thermostat unit may control HVAC equipment based on the temperature setpoint and operating mode change and update the weather data only after receiving an indication that there are no remaining messages.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A system for controlling heating, ventilation, or air conditioning (HVAC) equipment, the system comprising:
a thermostat unit configured control the HVAC equipment and operate in at least one of a first state or a second state, wherein the first state is a power-saving state and the second state is an operational state; and
a server comprising one or more processors configured to:
receive, from a remote device, one or more messages while the thermostat unit is in the first state;
store the one or more messages in a storage table;
receive a query from the thermostat unit responsive to the thermostat unit transitioning to the second state, the query indicating parameters of the thermostat unit and a state of the thermostat unit;
retrieve, responsive to the query, a first one of the one or more messages from the storage table;
generate a first message based on the first one of the one or more messages and the query; and
transmit the first message to the thermostat unit.

2. The system of claim 1, wherein the thermostat unit is configured to receive a user input indicating a change to a parameter of the thermostat unit while the thermostat unit is in the first state, and wherein the query further indicates the user input.

3. The system of claim 2, wherein generating the first message further comprises:
determining whether a change to the parameter of the thermostat unit associated with the first one of the one or more messages and the user input received by the thermostat unit are the same; and
merging the first one of the one or more messages and the user input based on a determination that the change to the parameter of the thermostat unit associated with the first one of the one or more messages and the user input are not the same.

4. The system of claim 3, the one or more processors further configured to:
retrieve, responsive to a determination that the change to the parameter of the thermostat unit associated with the first one of the one or more messages and the user input are the same, a second one of the one or more message from the storage table; and
generate the first message based on the second one of the one or more messages and the query.

5. The system of claim 4, wherein the thermostat unit is further configured to control the HVAC equipment according to the second message.

6. The system of claim 1, the one or more processors further configured to receive, from a user device, an operating schedule for the thermostat unit, wherein the thermostat unit is further configured to transition to the second state according to the operating schedule.

7. The system of claim 1, the one or more processors further configured to transmit, to the thermostat unit, an indication of a remaining number of the one or more messages stored in the storage table.

8. The system of claim 7, wherein the thermostat unit is configured to enter the first state responsive to an indication that there are no remaining messages of the one or more messages stored in the storage table.

9. The system of claim 1, wherein the one or more messages are stored in the storage table with a timestamp that indicates when each of the one or more messages was received.

10. The system of claim 1, wherein the server is a cloud based server and the server receives and transmits data in according to hypertext transfer protocol secure (HTTPS).

11. A method of controlling heating, ventilation, and/or air conditioning (HVAC) equipment, the method comprising:
receiving, from a remote device, one or more messages indicating changes to parameters of a thermostat unit associated with the HVAC equipment while the thermostat unit is in a power-saving state;
storing the one or more messages in a storage table;
receiving a query from the thermostat unit responsive to the thermostat unit transitioning to an operational state, the query indicating parameters of the thermostat unit;
retrieving, responsive to the query, a first one of the one or more messages from the storage table; and
transmitting a first message based on the first one of the one or more messages and the query to the thermostat unit.

12. The method of claim 11, wherein the thermostat unit is configured to receive a user input indicating a change to a parameter of the thermostat unit while the thermostat unit is in the power-saving state, and wherein the query further indicates the user input.

13. The method of claim 11, further comprising:
determining whether a change to the parameter of the thermostat unit associated with the first one of the one or more messages and the user input received by the thermostat unit are the same; and
merging the first one of the one or more messages and the user input based on a determination that the change to the parameter of the thermostat unit associated with the first one of the one or more messages and the user input are not the same.

14. The method of claim 13, further comprising retrieving, responsive to a determination that the change to the parameter of the thermostat unit associated with the first one of the one or more messages and the user input are the same, a second one of the one or more message from the storage table, wherein the first message is based on the second one of the one or more messages and the query.

15. The method of claim 11, the thermostat unit configured to control the HVAC equipment, the method further comprising controlling, by the thermostat unit, the HVAC equipment based on the first message.

16. The method of claim 11, further comprising receiving, from a user device, an operating schedule for the thermostat unit, wherein the thermostat unit is configured to transition to the operational state from a power-saving state according to the operating schedule.

17. The method of claim 11, further comprising transmitting, to the thermostat unit, an indication of a remaining number of the one or more messages stored in the storage table.

18. The method of claim 17, wherein the thermostat unit is configured to enter a power-saving state responsive to an indication that there are no remaining messages of the one or more messages stored in the storage table.

19. The method of claim 11, wherein the one or more messages are stored in the storage table with a timestamp that indicates when each of the one or more messages was received.

20. A thermostat unit capable of communicating with one or more servers, the thermostat unit comprising:
electronics configured to:
receive, from a remote device, a change to a parameter of a thermostat unit while the thermostat unit is in a first mode, wherein the first mode is a power-saving mode;
transmit a query to the server responsive to the thermostat entering a second mode, wherein the second mode is an operational mode;
control heating, ventilation, or air conditioning equipment based on a first message from the server, the first message comprising the change to the parameter of the thermostat unit;
determine a remaining number of messages stored on the server to be received; and
enter the first mode responsive to an indication that there are no messages to be received.
